(19) United States
(12) Patent Application Publication
(10) Pub. No.: US 2018/0147926 A1
(43) Pub. Date: May 31, 2018

(54) TONNEAU COVER WITH WATERTIGHT AND FLAT-SURFACE HINGES

(71) Applicants: Hang Shi, Changzhou (CN); Hongjuan Zheng, Changzhou (CN)

(72) Inventors: Hang Shi, Changzhou (CN); Hongjuan Zheng, Changzhou (CN)

(73) Assignee: Changzhou Sunwood International Trading Co. Ltd., Changzhou (CN)

(21) Appl. No.: 15/823,452

(22) Filed: Nov. 27, 2017

Related U.S. Application Data
(60) Provisional application No. 62/426,486, filed on Nov. 26, 2016.

(51) Int. Cl. B60J 7/14; B60J 7/10

(52) U.S. Cl. CPC B60J 7/141; B60J 7/104

(57) ABSTRACT

In accordance with embodiments of the present disclosure, a tonneau cover for covering a pickup truck's cargo bed may include a first panel and a second panel. Each of the first panel and the second panel may include on its one edge a corresponding hinge channel and a corresponding bulged sidewall. The tonneau cover may further include a hinge assembly for connecting the first panel with the second panel. The hinge assembly may include two hinge rails and a hinge trunk. The two hinge rails may be inserted into the corresponding hinge channels of the first panel and the second panel. And when the first panel and the second panel are in a closed position, the corresponding bulged sidewalls of the first panel and the second panel may be pressed against the hinge trunk to create a seal.

### CROSS REFERENCE TO RELATED APPLICATION

The present application is related to and claims the benefit of priority of the following commonly-owned, presently-pending provisional application: application Ser. No. 62/426,486, filed Nov. 26, 2016, entitled “A Tonneau Cover with Adjustable Locking Clamps and Watertight Hinges”, of which the present application is a non-provisional application thereof. The disclosures of the forgoing application are hereby incorporated by reference in it entirely, including any appendices or attachments thereof, for all purposes.

### BACKGROUND

Unless otherwise indicated herein, the approaches described in this section are not prior art to the claims in this application and are not admitted to be prior art by inclusion in this section.

Cargo bed covers have been used to cover the cargo beds of pickup trucks and protect cargo bed interior against dirt, debris and other environmental contaminants. In some cases, cargo bed covers are also used to improve the aesthetic quality of the pickup trucks. Conventional covers were designed by upholstery shops and typically made of vinyl covered fabrics or canvas. The material was often doubled over along its edges for added strength and appearance. Male snaps were then attached to the sides of the cargo box via fasteners, while female snaps were attached along the edges of the covers. Wooden bows were sometime used to span the cargo box and ensure that the covers remained high enough to drain water. Unfortunately these covers were sometimes difficult to handle, often led to corrosion around the snaps and occasionally failed to protect the cargo beds.

Over the years a wide variety of covers designs have been developed, in general these covers are known as either “caps” or “tonneau covers.” A cap is typically an enclosure that extends substantially above the cargo bed so as to increase the height of the cargo bed, while a tonneau cover typically lies substantially flush with the top walls of the cargo bed, without significantly increasing the height of the cargo bed. Many conventional tonneau cover systems are constructed of a solid or fabric material and employ an internal support frame work which installs to the cargo bed as a one-piece system. Occasionally these systems are hinged to provide an opening section thus providing access to the cargo bed to stowed cargo. Simple clamp methods are often employed to allow alignment and installation of the cover system to the cargo bed or allow quick removal of the tonneau cover from the cargo bed.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope. The disclosure will be described with additional specificity and detail through use of the accompanying drawings.

FIG. 1 illustrates a tonneau cover for a pickup truck;

FIG. 2 illustrates the inner side of a tonneau cover for the cargo bed of a pickup truck;

FIG. 3 illustrates the details of an expanded clamp assembly and a stored clamp assembly;

FIG. 4 illustrates the partial details of a clamp assembly;

FIG. 5 illustrates multiple views of a clamp assembly in a stored position;

FIG. 6 illustrates multiple views of a hinge assembly connecting two closed panels;

FIG. 7 illustrates detail views of hinge assemblies in a closed position; and

FIG. 8 illustrates additional detail views of hinge assemblies in a closed position;

all according to certain embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

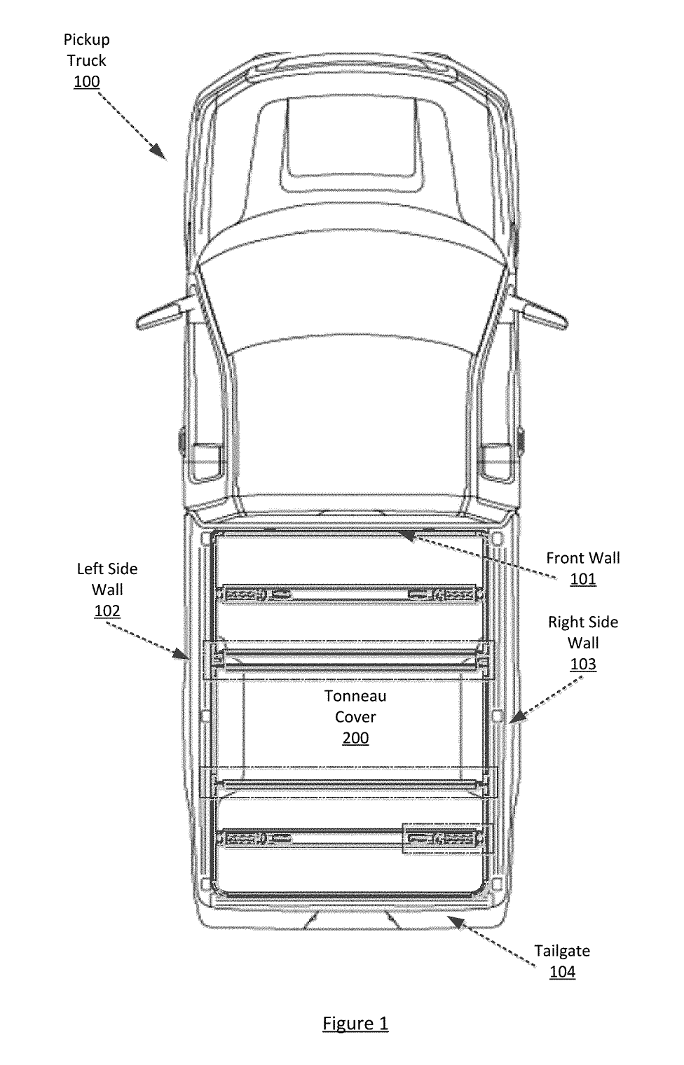

FIG. 1 illustrates a tonneau cover for a pickup truck, according of certain embodiments of the present disclosure. In FIG. 1, a tonneau cover 200 is used to cover the cargo bed of a pickup truck 100. The pickup truck 100 may be any vehicle having an opened/exposed cargo bed in its back. The cargo bed may include a front wall 101, a left-side wall 102, a right-side wall 103, as well as a tailgate (or back wall) 104. The left-side wall 102, the right-side wall 103, and/or the tailgate 104 may be individually and selectively opened or closed. The front wall 101, the left-side wall 102, the right-side wall 103, and tailgate 104 may be constructed using metal sheets rolled or jointed together, forming long, narrow, and relatively flat surfaces on the top of these walls. The tonneau cover 200 may be placed on, attached to, or supported by, the top flat surfaces of these walls, and may protect the inner space of the pickup truck 100's cargo bed from adverse weather, potential theft, or cargo-dislodging when the pickup truck 100 is stationary or in motion. The tonneau cover 200 may also be used to cover the interior space of any transportation device, whether powered or not, to cover any opened compartment; or to cover any physical structure having an opening.

For clarification purposes, once the tonneau cover 200 is installed onto the pickup truck's cargo bed, the side of tonneau cover 200 designed to face inside/interior of the cargo bed (or face down when installed and closed on the cargo bed) may be referred to as the “bottom” or “inner” side of the tonneau cover 200, and the other side of the tonneau cover 200 designed to face outside/exterior of the cargo bed (or face up when installed and closed on the cargo bed) may be referred to as the “top” or “outer” side of the tonneau cover 200. Further, various hinges and clamps of the tonneau cover 200 shown in FIG. 1 are for illustrative purposes. These hinges and clamps are located on the inner side of the tonneau cover 200, and should be hidden from external views when the tonneau cover 200 covers the cargo bed.

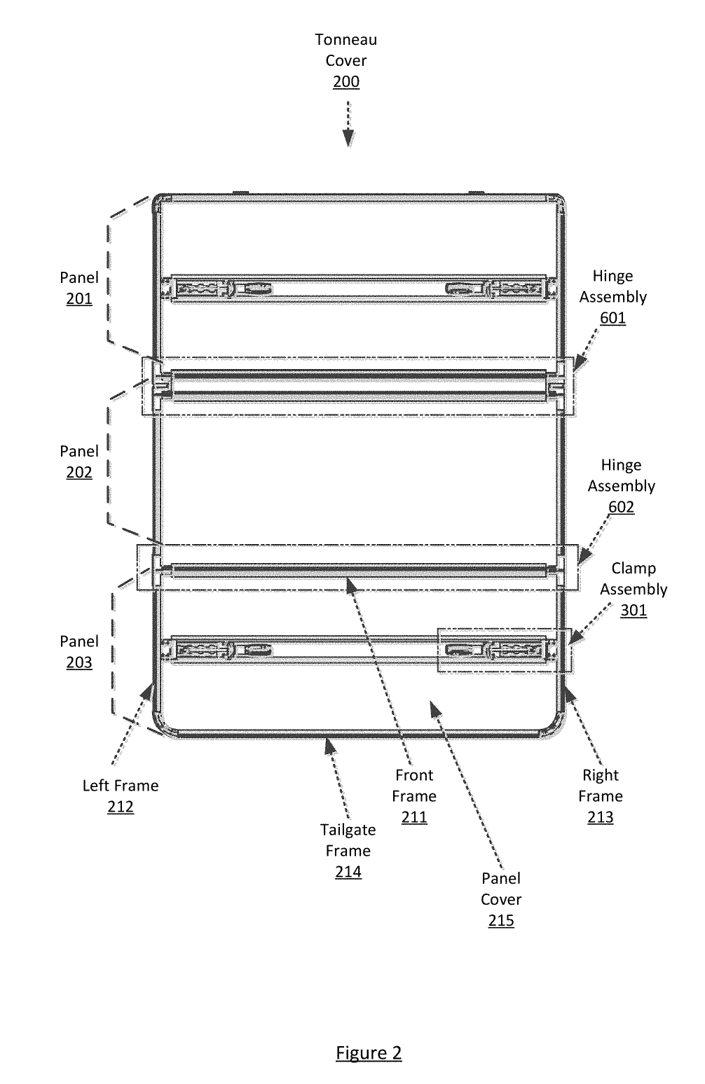

FIG. 2 illustrates the inner side of a tonneau cover for the cargo bed of a pickup truck, according of certain embodiments of the present disclosure. In FIG. 2, the tonneau cover 200 may be constructed using at least two, and preferably three or more panels (e.g., panel 201, panel 202, and panel 203). Each two adjacent panels may be connected using a corresponding hinge assembly. For example, panel 201 and panel 202 may be connected together using a hinge assembly 601, allowing the panel 201 and panel 202 to fold toward/away from each other. Likewise, panel 202 and panel 203 may be connected together using a hinge assembly 602, allowing the panel 202 and panel 203 to fold toward/away from each other.

For clarification purposes, each panel 201, 202, or 203 may have its four edges referred to as the north edge, east edge, south edge, and west edge in this disclosure. In other words, the hinge assembly 601 may connect the south edge of the panel 201 with the north edge of the panel 202, and the hinge assembly 602 may connect the south edge of the panel 202 with the north edge of the panel 203. Further, the hinge assemblies 601 and 602 may have a length that is substantially equal to the length of the north edges and south edges of the panels 201, 202, and 203.

FIG. 2 shows the tonneau cover 200 having all of the panels 201, 202 and 203 fully extended to cover the pickup truck's cargo bed. For clarification purposes, when the panels 201, 202, and 203 are covering the cargo bed, they may be referred to as in a “closed” position. In some embodiments, the panel 203, which is positioned near the pickup truck's tailgate, may be “opened” to expose part of the cargo bed previously covered by the panel 203. In other words, the tailgate frame 214 of the panel 203 may be opened upward and swung toward the panel 202, causing the panel 203 to rotate around the hinge assembly 602 before being flipped and placed on the top of panel 202. Furthermore, the panel 202, along with the panel 201 on its top, may be opened and swung toward the panel 201 around the hinge assembly 601, thereby further exposing the part of cargo bed that is previously being covered by the panel 202. Once the panel 202 and the panel 203 are opened and rested on the top of the panel 201, the majority of the cargo bed is exposed to allow easy access. In other embodiments, one panel may be “open” relative to the other panel that is connected via a hinge assembly. For example, the panel 203 may be relatively open with respect to the panel 202.

In some embodiments, each of the panels 201, 202, and 203 may have on the panels' edges a corresponding internal supporting frame work that is rigid enough to support the panels on the walls of the pickup truck cargo bed, and a corresponding panel cover shaped to be attached to the corresponding frame work. For example the panel 203 may have a frame work formed by a front frame 211 on its north edge, a left frame 212 on its east edge, a right frame 213 on its west edge, and a tailgate frame 214 on its south edge. The frames 211, 212, 213, and 214 may be constructed using materials such as wood, plastic, metal (e.g., steel or aluminum), polymer, or composites, and may be connected together to form a rigid framework. The sizes of the panels 201, 202, and 203 may be designed to fit the cargo bed of a particular make and model of pickup truck. During installation, the panel 203 may have its left frame 212 placed on and in contact with the top surface of the cargo bed's left-side wall, right frame 213 placed on the top surface of the cargo bed's right-side wall, and the tailgate frame 214 placed on the top surface of the tailgate.

In some embodiments, one or two panel covers 215 may be assembled on one or both sides of a panel. The panel cover 215 may be constructed using flexible material such as fabric, rubber, or leather. For increasing panel strength and protective purposes, the panel cover 215 may also be constructed using rigid, less flexible materials such as wood, plastic, fiberglass, polymer, composite, or metal.

In some embodiments, the panels of the tonneau cover 200 are connected to the hinge assemblies 601 and 602 in such a way that will provide a flat-surface on the top of the tonneau cover 200. In other words, each of the hinge assemblies 601 and 602 may connect two corresponding adjacent panels, and the resulting outer or top surface of the tonneau cover 200, which includes the top surface of the panels and the top of the hinge assemblies, is flat or substantially flat for less drag, easy clean-up, and better aesthetic purposes. Further, the hinge assemblies 601 and 602 may have hinge mechanisms that are watertight to prevent water or moisture entering into the interior of the pickup truck's bed when the tonneau cover 200 is in a closed position.

In some embodiments, some of the panels 201, 202 and 203 may be equipped with one or more clamp assemblies (e.g., clamp assembly 301) to fixate the panels to the walls of a cargo bed when these panels are in a closed position. For example, each of the inner side of the panel 201 and the inner side of the panel 203 may be equipped with one clamp assembly 301 on the right for grabbing/clamping onto the cargo bed's right-side wall, and another clamp assembly on the left for grabbing/clamping onto the cargo bed's left-side wall. In comparison, the inner side of the panel 202 may or may not be equipped with any clamps. By using these four clamp assemblies, the tonneau cover 200 may be securely attached to the cargo bed. And no additional tools may be required for installing the tonneau cover 200 or opening the tonneau cover 200 to access the cargo bed.

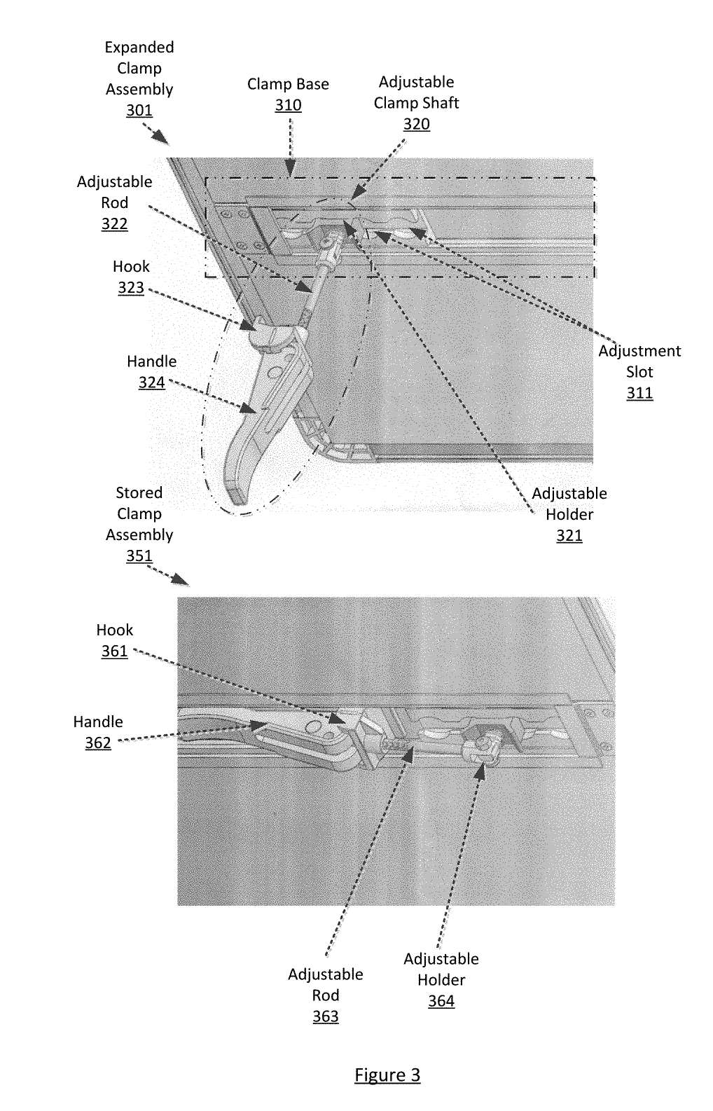

FIG. 3 illustrates the details of an expanded clamp assembly and a stored clamp assembly, according to certain embodiments of the present disclosure. In FIG. 3, the clamp assembly 301 may include a clamp base 310 and an adjustable clamp shaft 320 that is expanded out of the clamp base 310. In comparison, the clamp assembly 351 may have its adjustable clamp shaft stored in its clamp base. The clamp base 310 may include multiple adjustment slots 311. The adjustable clamp shaft 320 may include an adjustable holder 321, an adjustable rod 322, a hook 323, and a handle 324.

In some embodiments, the adjustable base 310 may be firmly installed near the edge of the inner side of panel, so that the hook 323 may be able to reach the side wall of the cargo bed. Each adjustment slot 311 on the adjustable base 310 may allow the adjustable holder 321 of the adjustable clamp shaft 320 to be installed therein, thereby changing the distance between the hook 323 and the side wall of the cargo bed. Specifically, each adjustment slot 311 on the clamp base 310 may have an “opening” and a “channel”, and all the opening and channels of the adjustment slots 311 are alternatively adjacent to one another. The bigger opening may allow the adjustable holder 321 of the adjustable clamp shaft 320 to be placed into the clamp base 310, and the narrower channel may allow the adjustable holder 321 to lock-in and hold-onto the clamp base 310. Depending on the installation needs, the adjustable holder 321 may be installed in any one of the adjustment slots 311 on the adjustable base 310.

In some embodiments, the first end of an adjustable rod 322 may be connected to the adjustment holder 321, and the second end of the adjustable rod 322 may be connected to a hook 323 and a handle 324. The adjustable rod 322 may have screw thread on the second end, allowing the hood 323 and handle 324 to screw in and out. When screwing in, the distance between the hook 323 and the adjustable holder 321 may become shorter. When screwing out, the distance between the hook 323 and the adjustable holder 321 becomes longer.

In some embodiments, the hook 323 may have a raised edge to grab onto the inner side wall of the cargo bed. The handle 324 may be used to move around the hook 323 until the hook 323 is in touch with the inner side wall of the cargo bed. Afterward, the handle 324 may be turned/rotated to allow the hook 323 to grab onto the inner side-wall of the cargo bed. Specifically, before the handle 324 is rotated, it may be in a mostly perpendicular position to the adjustable rod 322. After the handle 324 is rotated, it may be in a parallel position to the adjustable rod 322 (as shown in FIG. 3). Thus, by turning/rotating the handle 324, a user may quickly attach/detach the panel of the tonneau cover to/from the cargo bed, thereby allowing for quick opening and closing of the tonneau cover on the cargo bed.

In some embodiments, the turning/rotating of the handle 324 may increase/shorten the distance from the hook 323 to the adjustable holder 321. For example, when the handle 324 is perpendicular to the adjustable rod 322, the distance between the hook 323 and the adjustable holder 321 may be a first value. After the handle 324 is rotated, the distance between the hook 323 and the adjustable holder 321 may be a second value that is shorter than the first value. Thus, the rotating of the handler 324 may allow the raised edge of the hook 323 to tightly grab onto the inner side-wall of the cargo bed. If the hook 323 is loosely grabbing onto the inner side-wall of the cargo bed, or there are additional space between the raised edge of the hook 323 and the inner side-wall, the handle 324 may be rotated back to its perpendicular position, and the hook 323 and the handle 324 may be screwed into the adjustable rod 322, thereby shortening the distance between the hook 323 and the adjustable holder 321. Alternatively, the adjustable clamp shaft 320 may be placed into another adjustment slot 311, in order to allow the hook 323 to tightly grab onto the side-wall.

In some embodiments, the clamp assembly 351 shows the adjustable clamp shaft being placed into a compartment in the clamp base of the clamp assembly 351. When the panel is opened, its adjustable clamp shaft is no longer grabbing hold of the side-wall of the cargo bed. In this case, the compartment in the clamp base may be suitable for storing the adjustable clamp shaft, without letting it moving around. The adjustable rod 363 may be rotated to a specific angle with respect to the adjustable holder 364, and the length of the adjustable rod 363 may be adjusted by screwing actions. The handle 362 and the hook 361 may then be pushed into the compartment, and held in the compartment by friction or other securing means.

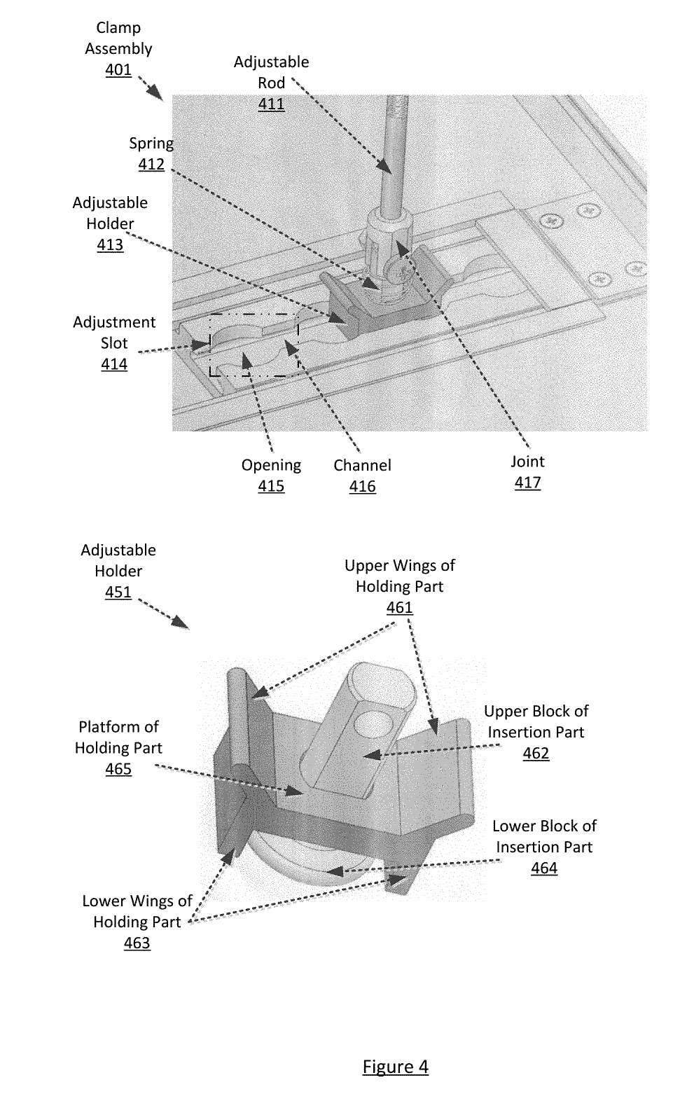

FIG. 4 illustrates the partial details of a clamp assembly, according to certain embodiments of the present disclosure. In FIG. 4, the clamp assembly 401 may have its clamp base and partial of its adjustable clamp shaft shown. The adjustable clamp shaft includes the adjustable rod 411, a spring 412, an adjustable holder 413, and a joint 417. The clamp base may have multiple adjustment slots 414, each of which includes an opening 415 and a channel 416. The adjustable rod 411 may be attached to the adjustable holder 413 using the joint 417.

In some embodiments, additional details are shown in the adjustable holder 451. Specifically, the adjustable holder 451 may include a “holding part” and an “insertion part.” The holding part may include two upper wings 461, two lower wings 463, and a platform 465. The platform 465 may have an opening as shown in FIG. 4 to allow the insertion part to be inserted. The insertion part may include an upper block 462 and a lower block 464, as well as an opening to be used for attaching to the adjustable rod via a joint. Further, the upper block 462 of the insertion part may be moved up-and-down through the opening on the platform 465. And the lower block 464 may have circular extension with a diameter that is larger than the diameter of the opening in the platform 465. Thus, the upper block 462 may only be moved up-and-down the opening on the platform 465 until the lower block 464 is blocked by the platform 465.

In some embodiments, the joint 417 may include a screw passing through an opening on the adjustable rod and an opening on the insertion part of the adjustable holder 413. The joint 417 may provide allow the adjustable rod 411 to rotate with respect to the adjustable holder 413. Further, the joint 417 may hold the spring 413 against the adjustable holder 413, thereby allowing the spring 413 to apply its tension on the holding part of the adjustable holder 413.

In some embodiments, a user may grab the two upper wings 461 of the holding part to pick up and move around the adjustable holder 451. The lower wings 463 are designed to be inserted into the openings 415 of a clamp base. Specifically, the width of the lower wings 463 may be smaller than the diameter of the opening 415, and the distance between the two lower wings 463 may be designed to allow both lower wings 463 to be inserted into the two openings 415. For example, the first lower wing 463 may be inserted into a first opening 415, and the second lower wing 463 may be inserted into an adjacent second opening 415. The first opening 415 and the second opening 415 may be connected via an in-between channel 416.

In some embodiments, to connect the adjustable clamp shaft to the claim base and place the adjustable holder 413 into the adjustment slot 414, a user may grab the two upper wings 461 to pick up the adjustable holder 413. By pushing the upper block 462 against the spring 412's tension, the upper block 462 may be moved in the opening on the platform 465, extending and exposing the lower block 464 out of the space enclosed by the two lower wings 463. Since the lower block 464 may have similar shape and size (e.g., approximately the same circular shape and diameter) as the opening 415, the extended lower block 464 may be freely inserted into the openings 415. The user may maintain the pressure applied to the spring 412, and slid the lower block 464 horizontally in the channel 416. Once the adjustable holder 451 is placed in an ideal adjustment slot 414 (e.g., the lower wings 463 are inserted into the two openings 415), the user may release the pressure applied to the spring 412, allowing the force/tension from the spring 412 to pull the lower block 464 against the inner walls of the channel 416, and push the holding part of the adjustable holder 413 against the adjustment slot 414.

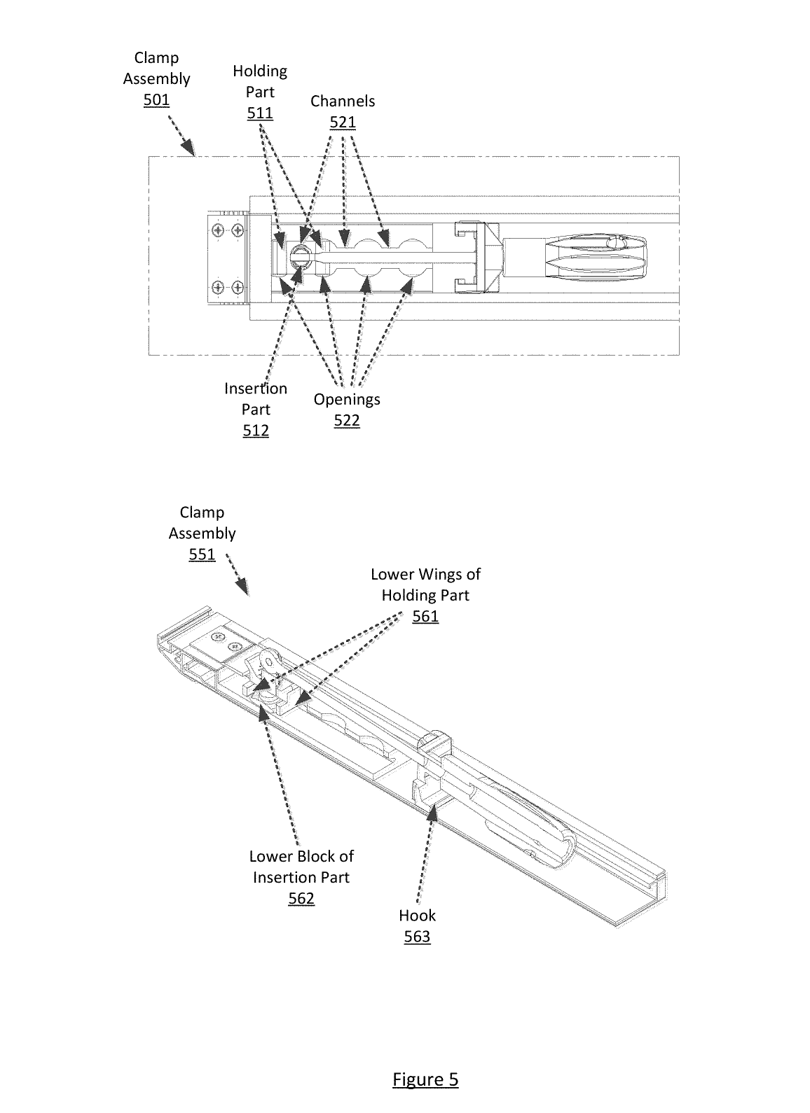

FIG. 5 illustrates multiple views of a clamp assembly in a stored position, according to certain embodiments of the present disclosure. Specifically, FIG. 5 shows a top view of a clamp assembly 501 with its adjustable clamp shaft stored in its clamp base. The clamp base may be equipped with multiple adjustment slots having multiple openings 522 and multiple channels 521 interconnecting these openings 522. The adjustable clamp shaft may have its adjustable holder inserted into one of the adjustment slots. In the stored position, the holding part 511 of the adjustable holder may have its two lower wings inserted in two of the openings 522, and the insertion part 512 of the adjustable holder may be secured in one of the channels 521.

FIG. 5 further shows a cut-away view of a clamp assembly 551 with its adjustable clamp shaft stored in its clamp base. The clamp base may be equipped with multiple adjustment slots. The adjustable clamp shaft may have its adjustable holder inserted into one of the adjustment slots. The adjustable holder may have a holding part and an insertion part. In the inserted position, the lower wings 561 of the holding part may be positioned in two of the openings of the adjustment slots, and the lower block 562 of the insertion part may be positioned in a channel of the adjustment slot. As shown in FIG. 5, the lower block 562 is locked into its location in the channel since the two lower wings 561 may prevent it from sliding sideway along in the channel, and the top of the channel is narrower than the lower block 562's diameter to prevent the lower block 562 from detaching away from the clamp base. FIG. 5 further illustrates the hook 563 of the adjustable clamp shaft being securely stored in the clamp base. The clamp base and the adjustable clamp shaft may be constructed from various materials such metal (e.g., steel, aluminum or an equivalent) or plastic.

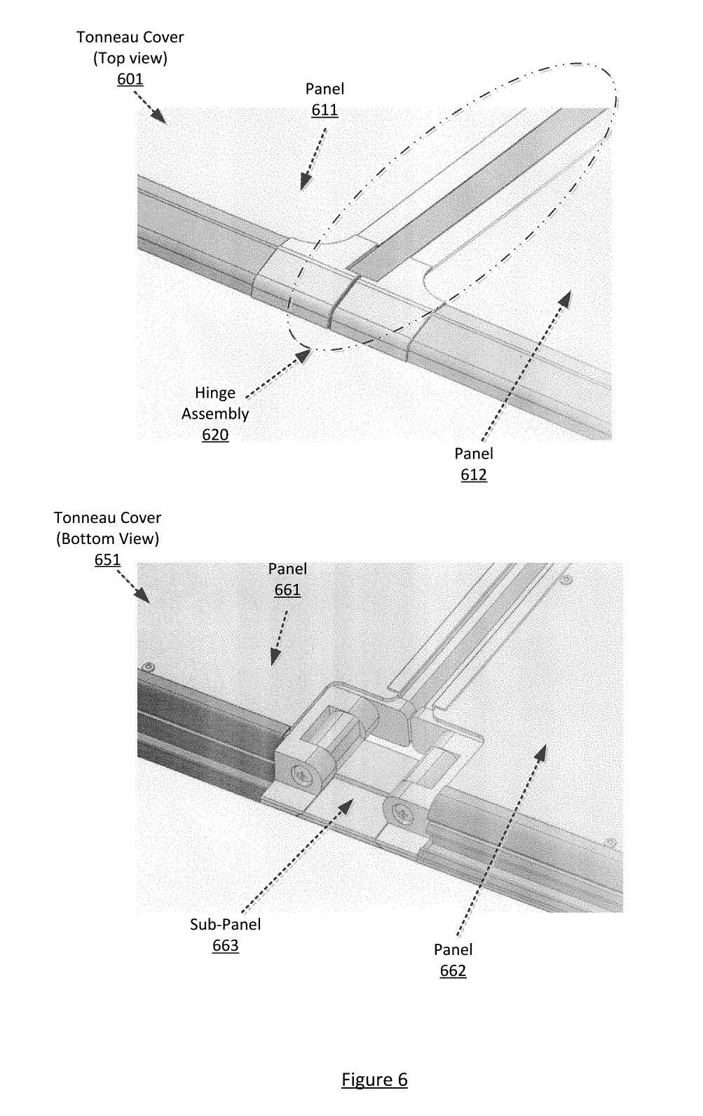

FIG. 6 illustrates multiple views of a hinge assembly connecting two closed panels, according to certain embodiments of the present disclosure. Specifically, FIG. 6 shows a partial top perspective view of a tonneau cover 601 having two closed panels 611 and 612 connected by a hinge assembly 620. The two panels 611 and 612 may have their top shown in FIG. 6. The hinge assembly 620 may extend the full or substantially the full length of the edges of the panels 611 and 612. The hinge assembly 620 may include a pivoting hinge component, which may allow the panels 611 and 612 to rotate with respect to each other around the hinge assembly 620. The hinge assembly 620 also allows the two panels 611 and 612 to flip and fold over on top of one another.

In some embodiments, to allow two folded panels folding over on top of a third panel, a sub-panel may be placed between one of the two panels and the third panel. FIG. 6 further shows a partial bottom perspective view of a tonneau cover 651 having two closed panels 661 and 662, as well as a closed sub-panel 663. A first hinge assembly may connect the panel 661 with the sub-panel 663, and a second hinge assembly may connect the sub-panel 663 with the panel 662. The sub-panel 663 may add additional space between the two panels 661 and 662 when they are folded over on top of each other, and the added space may be used for a third panel (not shown in FIG. 6). For example, the third panel may first be folded over on top of the panel 661, and the panel 661 and the third panel may then be treated as a unison, and be folded over op top of the panel 662. In other words, when being opened and folded, the sub-panel 663 may be perpendicular to the panel 661 and perpendicular to the panel 662 at the same time, thereby allowing the panel 661 and panel 662 to be parallel to each other,

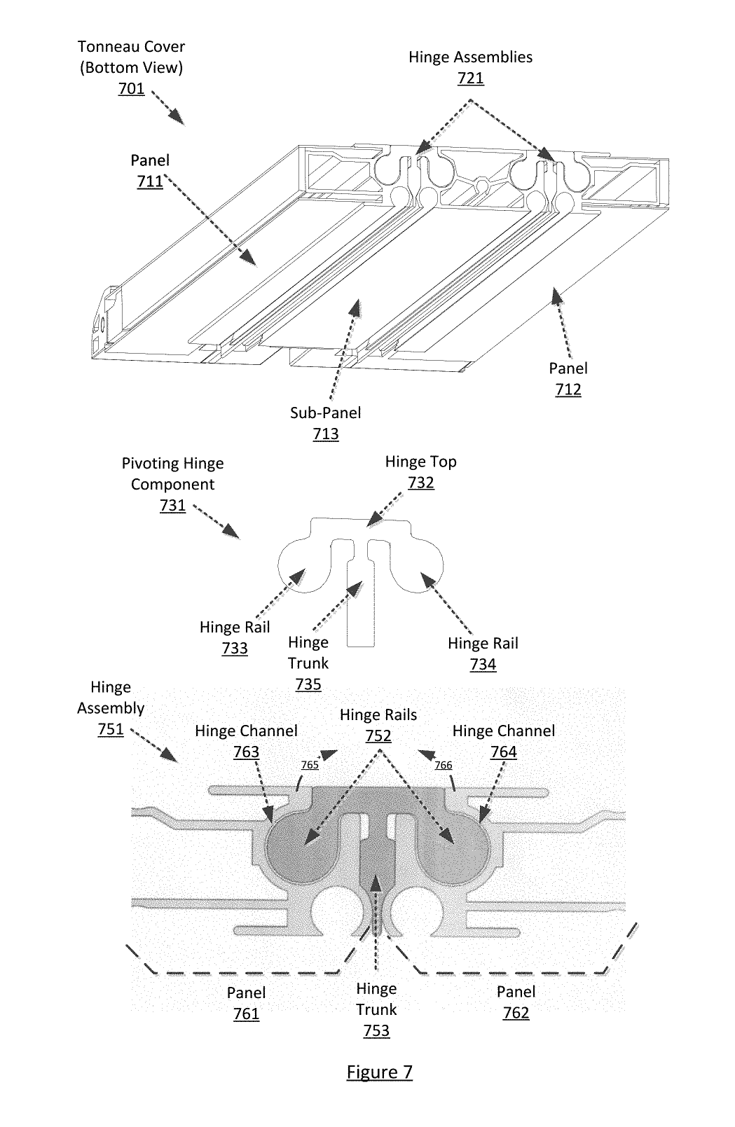

FIG. 7 illustrates detail views of hinge assemblies in a closed position, according to certain embodiments of the present disclosure. Specifically, FIG. 7 shows a partial bottom perspective view of a tonneau cover 701 having two panels 711 and 712, as well as a sub-panel 713, all connected using two hinge assemblies 721. For example, the panel 711 may be connected with the sub-panel 713 via a first hinge assembly 721, and the sub-panel 713 may then be connected with the panel 712 via a second hinge assembly 721. The hinge assemblies 721 may allow the panels 711, 712, and 713 to rotate and flip with respect to one another. Specifically, when opened and folded, the panel 711 may be perpendicular to the sub-panel 713, and the sub-panel 713 may be perpendicular to the panel 712 at the same time, thereby allowing the panel 711 to be placed on the top of the panel 712.

In FIG. 7, the tonneau cover 701's cut-away side view shows that each of the two hinge assemblies 721 may include a “pivoting hinge component”, which may be a long strip having a cross-sectional shape as shown in the pivoting hinge component 731. The pivoting hinge component 731 may contain a hinge top 732, two hinge rails 733 and 734 located substantially opposite to each other and connected to the two sides of the hinge top 732, and a hinge trunk 735 located between the two hinge rails 733 and 734 and having a trunk extending perpendicular to the hinge top 732. The hinge top 732 may be a long strip with flat top surface, and can be stretched or bended at around its center (as indicated by the pointer 732). Each of the hinge rails 733 and 734 may be a long rail with its cross-section in circular-shaped. The hinge trunk 735 may be a long strip with a cross-section in narrow rectangular shape. The pivoting hinge component 731 may be constructed using flexible and stretchable materials such as rubber or stretchable plastic. Further, the pivoting hinge component 731 not only provide pivoting and bending capabilities, but also serve as a seal for reducing friction, noise, and fluid leakage.

FIG. 7 further shows a cross-sectional view of a hinge assembly 751 connecting two closed panels 761 and 762. Specifically, each of the panels 761 and 762 may include on their sides a corresponding hinge channel 763 and 764 having a long and hollow chamber with a cross section being substantially circular. Specifically, the hinge channels 763 and 764 may have sidewalls formed by the same material (e.g., metal or alloy) as the panels. Thus, each of the sidewalls of the hinge channels 763 and 764 forms a circular hollow inner space, and has two edges creating an opening that allows the pivoting hinge component 731 to be inserted or slid into. The hinge channels 763 and 764 may have a diameter that is slightly larger than the diameter of the hinge rails 752, and may be designed to receive the hinge rails 752 using a sliding-in installation approach. Once the two hinge rails 752 are slid and installed into the hinge channels 763 and 764, the two panels 761 and 762 are connected by the pivoting hinge component.

To open the tonneau cover, the panels 761 and 762 may rotate toward each other in directions as illustrated by arrows 765 or 766. For example, when the panel 762 is fixated on the cargo bed, the panel 761 may be opened and fold toward the panel 762 in a direction as shown by the arrow 765. Likewise, when the panel 761 is fixated on the cargo bed, the panel 762 may be opened and fold toward the panel 761 in a direction shown by the arrow 766. The panels 761 and 762 may both folding toward each other at the same time. When the panels 761 and 762 are folding, the two hinge rails 752 are folding in the same directions as shown by the arrows 765 and 766. And the folding of the two hinge rails 752 may cause the hinge top of the hinge assembly 751 to bend. When the panels 761 and 762 are returned to the closed position, the hinge top of the hinge assembly 751 may return back to its original flat shape. Thus, the stretching, compressing, and bending of the hinge top may provide the pivoting capability of the hinge assembly 751.

In some embodiments, when the panels 761 and 762 are in a closed position, the hinge rails 752 may be pulled by the panels 761 and 762 toward opposite directions. The pulled hinge rails 752 may provide tensions at some of the contact points within the hinge channels 763 and 764. Such tensions may ensure a tight fit of the hinge rails 752 in the hinge channels 763 and 764. Further, the tight fit of the hinge rails 752 will also prevent external fluid or moisture from leaking or entering into the hinge channels 763 and 764. Also, when the panels 761 and 762 are closed, the inner sidewalls of these panels 761 and 762, which may be constructed with a bulged, expanded, or swollen shape, may contact and press against the hinge trunk 753. Such pressing against the hinge trunk 753 ensures the panels 761 and 762 will not move around or make noise during vehicle movements. Further, the pressed hinge trunk 753 will prevent any fluid leakage from entering into the cargo bed.

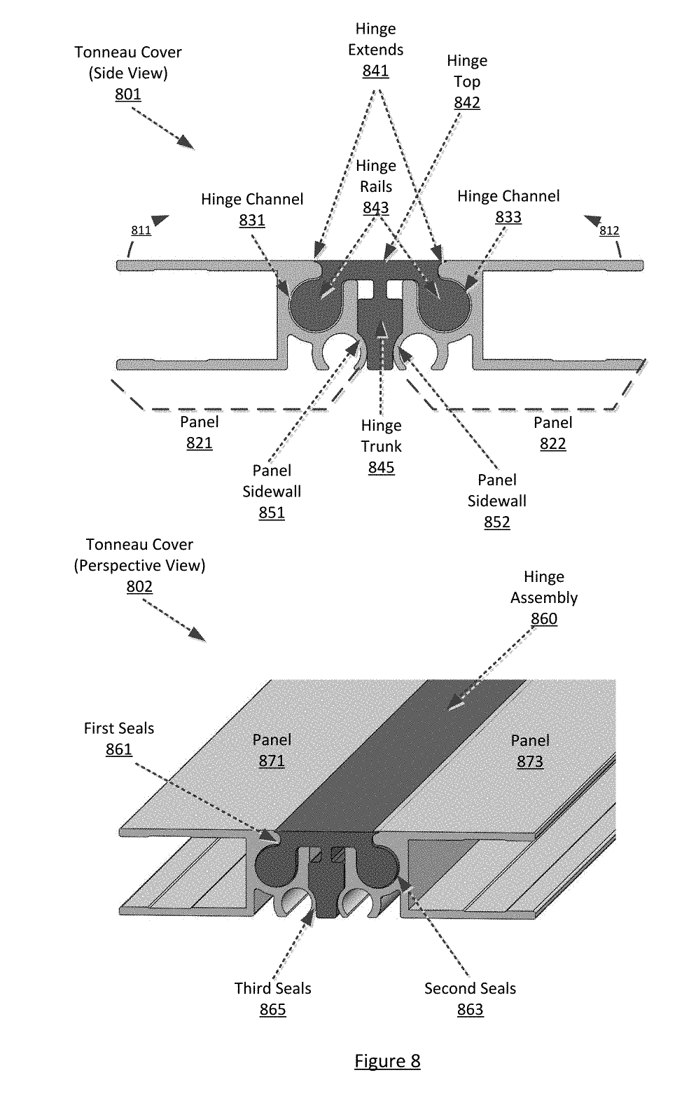

FIG. 8 illustrates additional detail views of hinge assemblies in a closed position, according to certain embodiments of the present disclosure. Specifically, FIG. 8 shows a partial side (or cross-sectional) view of a tonneau cover 801 having two panels 821 and 822 connected using one hinge assembly. The hinge assembly may allow the panels 821 and 822 to rotate and flip with respect to one another. The tonneau cover 801's side view shows that the hinge assembly may include a “pivoting hinge component”, which may be a long strip of connecting material having a cross-sectional shape as shown in the pivoting hinge component 731 of FIG. 7.

Referring back to FIG. 8, the pivoting hinge component may contain a hinge top 842, two hinge rails 843, and a hinge trunk 845. The hinge top 842 may be a long stripe with flat top surface, and can be stretched or bended at around its center location (as indicated by the pointer 842). Each of the hinge rails 843 may be a long rail of material with its cross-section in circular shape. The hinge rails 843 may be substantially opposite to each other and connected to the two sides of the hinge top 842. The hinge trunk 845 may be a long strip with a cross-section in narrow rectangular shape, and may have the narrow rectangular shaped trunk extending perpendicular to the hinge top 842. The pivoting hinge component may be constructed using flexible and stretchable/compressible materials such as rubber or stretchable/compressible plastic. Further, the pivoting hinge component not only provide pivoting and bending capabilities, but also serve as a seal for reducing friction, noise, and fluid leakage.

FIG. 8 shows the pivoting hinge component being inserted into the panels 821 and 822, thereby creating a hinge assembly connecting the two closed panels 821 and 822. Specifically, each of the panels 821 and 822 may include a corresponding hinge channel 831 and hinge channel 833, each of which having a long, circular-shaped cross section, and hollow chamber. The hinge channels 831 and 833 may have a diameter that is slightly larger than the diameter of the hinge rails 843, and may be designed to receive the hinge rails 843 using a sliding-in installation approach. Once the two hinge rails 843 are slid and installed into the hinge channels 831 and 833, the two panels 821 and 822 are connected via the hinge assembly.

To open the tonneau cover, the panels 821 and 822 may rotate toward each other in directions as illustrated by arrows 811 or 812. For example, the panel 822 may be opened and fold toward the panel 821 in a direction as shown by the arrow 812. Likewise, the panel 821 may be opened and fold toward the panel 822 in a direction shown by the arrow 811. Both panels 821 and 822 may also simultaneously fold toward each other. When the panels 821 and 822 are folding, the two hinge rails 843 are folding in the same directions as shown by the arrows 811 and 812. And the folding of the two hinge rails 843 may cause the hinge top 842 of the hinge assembly to bend. When the panels 821 and 822 are returned to the closed position, the hinge top of the hinge assembly may return back to its original flat shape. Thus, the stretching and bending of the hinge top 842 may provide the pivoting capability of the hinge assembly.

In some embodiments, when the panels 821 and 822 are in a closed position, the hinge rails 843 may be pulled by the panels 821 and 822 toward opposite directions. The pulled hinge rails 843 may provide tensions at some of the contact points within the hinge channels 831 and 833. Such tensions may ensure a tight fit of the hinge rails 843 in the hinge channels 831 and 833. Further, the tight fit of the hinge rails 843 will also prevent external fluid from leaking into the hinge channels 831 and 833. In addition, the panels 821 and 822 may have two panel sidewalls 851 and 852 having a bulged, expanded, or swollen shape. When the panels 821 and 822 are in a closed position, the two bulged panel side walls 851 and 852 may have a closer distance between each other, thereby reducing the space between the two panels 821 and 822. Thus, when the panels 821 and 822 are closed, the sidewalls 851 and 852 of these panels 821 and 822 may contact and press against the hinge trunk 845, which may be constructed using compressible material. Such pressing against the hinge trunk 845 may compress the hinge trunk 845, thereby ensuring the panels 821 and 822 not moving around or making noise during vehicle movements. Further, the pressed hinge trunk 845 will prevent any fluid leakage from entering into the cargo bed.

In some embodiments, the pivoting hinge component may have two hinge extends 841 close to the hinge top 842 and between the hinge top 842 and the hinge rails 843. The hinge extends 841 may be in contact with the top edges of the panels 821 and 822 at all time, thereby providing a tight embracing of the top edges of the panels 821 and 822. Specifically, the hinge extends 841 may be constructed using stretchable and compressible material, so that the top edges of the panels 821 and 822 may press into the material to create the semi-circular shape as shown in FIG. 8.

FIG. 8 further shows a partial perspective view of a tonneau cover 802 having two panels 871 and 873 connected using one hinge assembly 860. The hinge assemblies may allow the panels 871 and 873 to rotate and flip with respect to one another. The tonneau cover 802's perspective view shows that the hinge top of the hinge assembly 860 and the top surfaces of the panels 871 and 873 forming a flat surface. Further, when the hinge assembly 860 is assembled with the panels 871 and 873, it may form at least three seals 861, 863, and 865, thereby reducing the amount of external liquid or moisture from leaking through the gaps between the hinge assembly 860 and the panels 871 and 873.

Specifically, the first seal 861 may be formed by the hinge assembly 860's hinge extends and the edges of the panels 871 and 873. If there is any water leaking through the first seal 861 and entering into the hinge channels of the panels 871 and 873, the hinge rails of the hinge assembly 860 and the hinge channels of the panels 871 and 873 may form a second seal 863 to prevent any water entering into the hinge channels from traveling between the gaps. Even if there may be some moisture exiting the hinge channels and entering into the space between the two panels 871 and 873, the hinge trunk of the hinge assembly 860, which when being pressed by the two extended sidewalls of the closed panels 871 and 873, may stop such moisture from passing the gaps between the hinge trunk and the sidewalls of the panels and entering into the interior of the truck bed. Thus, the hinge assembly 860 may provide at least three seals to create watertight connections for the panels.

Thus, multiple embodiments of a tonneau cover for pickup truck's cargo bed have been described. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense.

One skilled in the art will appreciate that, for this and other apparatuses and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments. Moreover, one or more of the outlined steps and operations may be performed in parallel.

We claim:

1. A tonneau cover for covering a pickup truck's cargo bed, comprising:
a first panel and a second panel, wherein each of the first panel and the second panel includes on its one edge a corresponding hinge channel and a corresponding bulged sidewall; and
a first hinge assembly for connecting the first panel with the second panel, wherein the first hinge assembly includes two hinge rails and a hinge trunk, wherein the two hinge rails are inserted into the two corresponding hinge channels of the first panel and the second panel, and when the first panel and the second panel are in a closed position, the corresponding bulged sidewalls of the first panel and the second panel are pressed against the hinge trunk to create a first seal.

2. The tonneau cover of claim 1, wherein when the first panel and the second panel are in the closed position, the hinge top of the first hinge assembly and the top surfaces of the first panel and the second panel form a flat surface.

3. The tonneau cover of claim 1, wherein when the first panel and the second panel are in the closed position, the two hinge rails of the first hinge assembly are stretched away from each other, thereby creating second seals in the hinge channels of the first panel and the second panel.

4. The tonneau cover of claim 3, wherein two hinge extends of the first hinge assembly have contacts with the edges of the first panel and second panel, thereby creating third seals at the contacts.

5. The tonneau cover of claim 1, wherein the first hinge assembly is made of stretchable and compressible rubber or plastic.

6. The tonneau cover of claim 1, further comprising:
a third panel; and
a second hinge assembly for connecting the second panel with the third panel, wherein the first hinge assembly is configured to allow the first panel to fold on top of the second panel, and the second hinge assembly is configured to allow the first panel and the second panel to fold on top of the third panel.

7. The tonneau cover of claim 1, further comprising:
a third panel; and
a second hinge assembly for connecting the second panel with the third panel, wherein the first hinge assembly is configured to allow the first panel to fold perpendicular to the second panel, and the second hinge assembly is configured to allow the second panel to fold perpendicular to the third panel, thereby allowing the first panel to fold on top of the third panel.

8. The tonneau cover of claim 1, further comprising:
a first clamp assembly installed on the first panel's inner side; and
a second clamp assembly installed on the second panel's inner, wherein the first clamp assembly and the second clamp assembly are configured to clamp the tonneau cover onto the pickup truck's cargo bed.

9. A hinge assembly for connecting a first panel and a second panel, the hinge assembly is a long strip having:
two hinge rails located on two sides of the long strip; and
a hinge trunk positioned between the two hinge rails,
wherein the hinge rails are inserted into two corresponding hinge channels of the first panel and the second panel, and when the first panel and the second panel are closed, two corresponding bulged sidewalls of the first panel and the second panel are pressed against the hinge trunk to create a first seal.

10. The hinge assembly of claim 9, further comprising:
a hinge top connecting the two hinge rails and the hinge trunk, wherein when the first panel and the second panel are in a closed position, the hinge top and two top surfaces of the first panel and the second panel form a flat surface.

11. The hinge assembly of claim 10, further comprising:
two hinge extends each of which is located between the hinge top and a corresponding one of the hinge rails, wherein the two hinge extends have contacts with two edges of the first panel and second panel, thereby creating second seals at the contacts.

12. The hinge assembly of claim 11, wherein when the first panel and the second panel are in the closed position, the two hinge rails are stretched away from each other in the hinge channels, thereby creating third seals in the hinge channels of the first panel and the second panel.

13. The hinge assembly of claim 9, wherein the hinge assembly is made of stretchable and compressible rubber or plastic.

14. A tonneau cover for covering a pickup truck's cargo bed, comprising:
a first panel having on its one edge a first hinge channel and a first bulged sidewall;
a second panel having on its one edge a second hinge channel and a second bulged sidewall, and on its other edge a third hinge channel and a third bulged sidewall;
a third panel having on its one edge a fourth hinge channel and a fourth bulged sidewall;
a first hinge assembly for connecting the first panel with the second panel, wherein the first hinge assembly includes a first hinge trunk, a first hinge rail for inserting into the first hinge channel, and a second hinge rail for inserting into the second hinge channel, and when the first panel and the second panel are in a closed position relative to each other, the first bulged sidewall and the second bulged side wall are pressed against the first hinge trunk; and
a second hinge assembly for connecting the second panel with the third panel, wherein the second hinge assembly includes a second hinge trunk, a third hinge rail for inserting into the third hinge channel, and a fourth hinge rail for inserting into the fourth hinge channel, and when the second panel and the third panel are in a closed position relative to each other, the third bulged sidewall and the fourth bulged side wall are pressed against the second hinge trunk.

15. The tonneau cover of claim 14, further comprising:
a first clamp assembly installed on the first panel's inner side; and
a second clamp assembly installed on the second panel's inner side,
wherein the first clamp assembly and the second clamp assembly are configured to clamp the tonneau cover onto the pickup truck's cargo bed.

16. The tonneau cover of claim 14, wherein when the first panel, the second panel, and the third panel are in the closed position, the hinge tops of the first hinge assembly and the second hinge assembly, and the top surfaces of the first panel, the second panel, and the third panel form a flat surface.

17. The tonneau cover of claim 14, wherein when the first panel and the second panel are in the closed position, the first hinge rail and the second hinge rail of the first hinge assembly are stretched away from each other, thereby creating first seals in the first hinge channel of the first panel and the second hinge channel of the second panel.

18. The tonneau cover of claim 14, wherein the first hinge assembly is configured to allow the first panel to fold on top of the second panel, and the second hinge assembly is configured to allow the first panel and the second panel to fold on top of the third panel.

19. The tonneau cover of claim 14, wherein the first hinge assembly is configured to allow the first panel to fold perpendicular to the second panel, and the second hinge assembly is configured to allow the second panel to fold perpendicular to the third panel, thereby allowing the first panel to fold on top of the third panel.

20. The tonneau cover of claim 14, wherein the first hinge assembly and the second hinge assembly are made of stretchable and compressible rubber or plastic.
